(19) United States
(12) Patent Application Publication
(10) Pub. No.: US 2025/0363169 A1
(43) Pub. Date: Nov. 27, 2025

(54) ENTERTAINMENT MANAGEMENT

(71) Applicant: NoSongRequests.com, Inc., Moorpark, CA (US)

(72) Inventor: Lincoln Manning, Moorpark, CA (US)

(21) Appl. No.: 18/835,830

(22) PCT Filed: Mar. 20, 2024
(86) PCT No.: PCT/US2024/020811

§ 371 Date: Aug. 5, 2024

Related U.S. Application Data
(60) Provisional application No. 63/453,460, filed on Mar. 20, 2023.
(60) Provisional application No. 63/521,089, filed on Jun. 14, 2023.
(60) Provisional application No. 63/523,906, filed on Jun. 28, 2023.
(60) Provisional application No. 63/564,984, filed on Mar. 13, 2024.
(60) Provisional application No. 63/639,478, filed on Apr. 26, 2024.

(51) Int. Cl. G06F 16/635; G06F 16/638; G06Q 20/10; G06Q 30/0241

(52) U.S. Cl. CPC G06F 16/635; G06F 16/638; G06Q 20/10; G06Q 30/0241

(57) ABSTRACT

Systems and methods of managing entertainment may be used to facilitate communications between an audience and a DJ. These communications can include song requests, shout outs, payments, social connections, and/or promotion of entertainment content. The systems and methods are optionally used at live events.

### CROSS-REFERENCE TO RELATED APPLICATIONS

This application claims benefit of and priority to U.S. patent applications 63/453,460 filed 20 Mar. 2023; 63/521,089 filed 14 Jun. 2023; 63/523,906 filed 28 Jun. 2023 and 63/564,984 filed 13 Mar. 2024; the disclosures of which are hereby incorporated herein by reference in their entirety.

### BACKGROUND

### Field of the Invention

The invention is in the field of communication between an entertainer and their audience. Some embodiments include financial transactions and or promotion of specific content.

### Related Art

In a typical live event, a DJ may receive a request by having the name of a song or artist yelled at them. Sometimes a bit of beer is spilled during this process.

### SUMMARY

Communications between entertainers and their audiences are facilitated using a computing device, such as a smartphone or tablet computer. Entertainers can include performers, musicians, artists, or DJs, etc. Communications from an audience member to a DJ (Disc Jockey) may be used to make song requests or to request a shoutout. Communications to the audience members may include social media posts, chat messages, images, suggestions for entertainment content, and or the like. In some embodiments, the communications include a payment (e.g., a tip) from the audience member to a DJ. Communications may be facilitated by a website and/or downloadable applications. In some embodiments, the DJ may be any person or system that manages the delivery entertainment content in response to audience requests and is not limited to the traditional radio or club DJ. In some embodiments communications further include an event organizer.

In some embodiments, suggestions for entertainment content include promoted material. For example, a promoter or artist may pay to have a song suggested to an audience member as song to be requested. As is described further herein, there are a variety of ways in which content may be suggested to an audience member.

Various embodiments include an entertainment management system comprising: audience interface logic configured to present an audience user interface, the audience user interface being configured for an audience member to enter a song request and to initiate a financial transaction including a payment to a DJ; transaction logic configured to facilitate the financial transaction; communication logic configured to communicate the song request to the DJ; and DJ interface logic configured to present the song request to the DJ.

Various embodiments include a method of performing a financial transaction between a DJ and an audience member, the method comprising: providing an audience user interface to the audience member; providing a recommendation list to the audience member, the recommendation list including songs, artists, and/or genres; receiving a selection from the recommendation list from the audience member via the audience user interface; optionally receiving a request for a shoutout from the audience member via the audience user interface, and providing the request for a shoutout to the DJ; providing the audience member an opportunity to send a tip to the DJ via the audience user interface; receiving a tip amount from the audience member; and facilitating a financial transaction between the audience member and the DJ based on the tip amount.

Various embodiments include a method of promoting entertainment content, the method comprising: optionally receiving request requirements from a DJ, the request requirements including criteria for songs, artists, and/or genres; generating a recommendation list of songs, artists, and/or genres, the recommendation list optionally being based on the request requirements; adding promoted entertainment content to the recommendation list; presenting the recommendation list to an audience member; receiving a selection by the audience member, of a song, artist, and/or genre, from the recommendation list, the selection optionally including the promoted entertainment content; and reporting the receive selection to a DJ.

Various embodiments include a method of managing an event the method including: optionally designating parts of the event; providing an audience interface configured for participants in the event to request songs, optionally in association with the parts of the event; receiving requests for the songs from the participants; providing the requests to an organizer of the event; receiving an approval of one or more of the requests from the organizer; and providing the approved one or more of the requests to a DJ, the DJ optionally being a party other than the organizer.

Various embodiments include a method of distributing photographs related to a managed event, the method comprising: providing an audience interface to participants in an event, the audience interface being configured for the participants to upload photos of the event; receiving the photos from the participants; providing the photos to an organizer of the event; receiving approval of the photos from the organizer; posting the approved photos to a virtual photo album; and optionally restricting access to the virtual photo album to the participants.

A managed event optionally includes a wedding, birthday party, celebration, concert or similar social event, and the organizer may be a bridal party, venue owner, promotor, or their designated agent. The participants are optionally limited to invited guests and/or audience members verified as being at a specific location. An event and/or a venue can be virtual and/or physical. For example, a dance party may be held at a physical venue and have both in-person and virtual audience members.

Various embodiments of the invention include a method of transitioning between songs in a play list, the method comprising: identifying a first song of the playlist and first characteristics of the first song at an end of the first song; identifying a second song of the playlist and second characteristics of the second song at a beginning of the second song, the first and second songs of the playlist being in sequential order in the playlist; providing the first characteristics and the second characteristics to a machine learning system, the machine learning system being trained to generate a musical interlude configured to bridge a transition between the first song and the second song, the generation being based at least in part on the first characteristics and the second characteristics; receiving the musical interlude from the machine learning system; and playing the first song, the musical interlude and the second song, in sequential order to an audience.

Various embodiments of the invention include a method of establishing a social network, the method comprising: identifying parties at an event optionally including a DJ; and providing an audience interface in which attendees of the event can connect to each other on a membership limited social network, and optionally provide tips to the DJ, wherein the social network is limited in membership to audience members, venue owners and DJs who were at a specific venue during certain times; wherein the social network is temporary is limited in time (lasting only) based on timing of the event.

### BRIEF DESCRIPTION OF THE DRAWINGS

FIG. 1 illustrates an entertainment management system, according to various embodiments of the invention.

FIG. 2 illustrates methods of performing a financial transaction between a DJ and an audience member, according to various embodiments of the invention.

FIG. 3 illustrates methods of promoting entertainment content, according to various embodiments of the invention.

FIG. 4 illustrates methods of managing an event, according to various embodiments.

FIG. 5 illustrates methods of distributing photographs, according to various embodiments.

FIGS. 6A and 6B illustrate methods of generating a playlist including smooth transitions between songs, according to various embodiments.

FIG. 7 illustrates methods of transitioning between songs using a musical interlude, according to various embodiments.

FIG. 8 illustrates user interfaces configured to access event logic, according to various embodiments of the invention.

FIG. 9 illustrates a method of establishing a social network, according to various embodiments of the invention.

### DETAILED DESCRIPTION

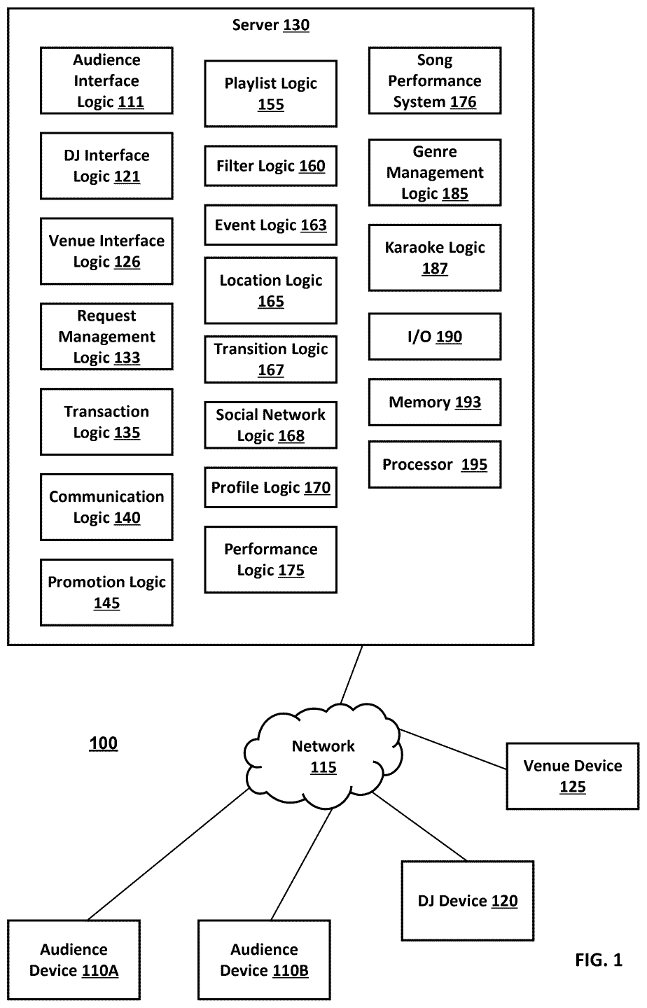

FIG. 1 illustrates an Entertainment Management System 100, according to various embodiments of the invention. Entertainment Management System 100 is configured for the management of music, video and/or other types of entertainment media. In various embodiments, Entertainment Management System 100 may be used by a DJ at a live event, at a recorded event, at an in-person event, and/or at a remote event. In some cases, Entertainment Management System is used to manage streamed entertainment.

Notable aspects of Entertainment Management System 100 include optional systems and methods of making requests for various types of media, filtering of those requests, providing suggestions of media to request, and/or facilitating tips and/or other transactions between DJs, Audience members and third parties (e.g., artists or record companies). Tips May be divided between DJs, venues, organizers, and/or a provider of Entertainment Management System 100. While music is used as an example herein, Entertainment Management System 100 and the examples discussed herein may be adapted to manage other types of media, such as video, audio, or interactive content.

Entertainment Management System 100 optionally includes a Server 130 in communication with various client devices. The communication is optionally over a Network 115 such as the internet, a wireless network, a cellular network, and/or other communication network. The client devices can include Audience Devices 110 (individually designated 110A, 110B, etc.), one or more DJ Device 120, and/or one or more Venue Device 125. Network 115 may also be configured to communicate with devices of other parties, such as artists, advertisers, music promoters, event organizers, and/or the like (not shown).

Server 130 may include one or more computing devices and may be distributed among multiple locations. The elements of Server 130 illustrated in FIG. 1 are alternatively included (in any combination) in Audience Devices 110, DJ Devices 120, and/or Venue Devices 125. For example, logic configured to present an interface to an audience member may be disposed within an application executed on a smartphone of the audience member. Server 130 is optionally configured to provide such applications to the other elements illustrated in FIG. 1.

Server 130 typically includes Audience Interface Logic 111, Audience Interface Logic 111 is configured to present an audience user interface to audience members. The audience members may be guests at an entertainment venue (e.g., a dance club), people at an event (e.g., a wedding or party), and/or people listening remotely. The audience user interface is configured for an audience member to enter a song request and/or to initiate a financial transaction including a payment to a DJ or other party. All or part of Audience Interface Logic 111 may be disposed on Audience Devices 110, e.g., as a smartphone app. In some embodiments, Audience Interface Logic 111 is configured to provide a browser based interface accessible via a link, QR code, RFID data, and/or the like.

Audience Interface Logic 111 is typically configured to provide a user interface to audience members, through which the audience members can: request songs from a DJ, view a list of suggested songs to request, view what other audience members have suggested, make payments to DJs, and/or perform other actions disclosed herein. For example, in some embodiments Audience Interface Logic 111 is configured to present a list of requestable songs, artists, and/or genres (a recommendation list) to audience members. This list is optionally generated using a trained machine learning system, pre-selected by the DJ, filtered according to genre, filtered to match characteristics of songs on a DJ's playlist, generated using characteristics of songs designated by a DJ, filtered by artist, filtered by appropriate audience age, filtered using a no-play list, and/or the like. For instance, a DJ may designate that the recommendation list only includes songs or artists having a quantifiable similarity to songs on a playlist of the DJ.

Audience Interface Logic 111 is optionally configured to present one or more promoted songs and/or promoted artists to audience members. This promoted song (or artist) is optionally included in the recommendation list of songs that may be requested. For example, the audience member interface may include a promotional advertisement for an artist and/or include one or more songs by that artist in the recommendation list of suggested songs to be requested. The promotional advertisement may include a “banner advertisement” displayed on the user interface and/or inclusion of a song title in the list of songs.

Audience Interface Logic 111 is optionally configured to present one or more songs (the recommendation list) to audience members, as songs to be requested, where the presented songs are pre-approved by the DJ. For example, in some embodiments a DJ may provide a planned playlist for an event and Audience Interface Logic 111 is configured to include songs from this playlist for inclusion in the recommendation list of songs suggested to audience members as being good requests. Such a restriction of songs that may be requested may be useful when the “DJ” includes a live performer who is ready to play a limited list of requested songs. In another example, a DJ may preapprove an artist and/or a genre and Audience Interface Logic 111 is configured to present songs by the artist or from the genre in the list of songs to be requested. In a specific example, Audience Interface Logic 111 is configured to present a list of selectable (optionally DJ approved) genre to an audience member, to present a list of songs already requested by other audience members, and/or to present a list of songs (optionally DJ approved) to the audience member. The recommendation list is optionally generated using Filter Logic (160) discussed elsewhere herein.

Audience Interface Logic 111 is typically further configured to generate an audience user interface configured to receive a selection of a song, artist, and/or genre from an audience member. This selection may or may not be required to be from the recommendation list. Audience Interface Logic 111 is typically further configured to receive a tip and/or a message from audience members, for payment or communication to the DJ. For example, the audience interface may be configured to receive a title of a requested song and an amount of tip to be provided to the DJ.

Audience Interface Logic 111 is optionally configured to help an audience member identify a song by artist, lyrics, and/or audio segment. For example, an audience interface generated by Audience Interface Logic 111 may be configured to receive a few words of lyrics with which Audience Interface Logic 111 can search for songs including those lyrics. A similar search may be performed using a short audio segment including a melody. Songs may be searched for by first identifying a genre and/or artist and then searching for songs within that scope. Audience Interface Logic 111 may also be configured to present audience members with a text input field configured to receive artist or song names from audience members for the audience members to request.

In various embodiments, Audience Interface Logic 111 is configured to generate audience (user) interfaces configured for an audience member to setup and edit their profile, communicate with other parties (e.g., other audience members, DJs, artists, venues, event organizers, and/or music promoters), and/or interact with a social network. For example, Audience Interface Logic 111 may be configured for an audience member to search for and review DJ profiles, to search for and review venue profiles (e.g., find a venue performance schedule for a specific DJ), and/or to communicate with other audience members via a social network.

In some embodiments, Audience Interface Logic 111 is configured to allow an audience member to join (and optionally pay for) a virtual event. For example, an audience member May wish to remotely attend an event streamed (or pre-recorded) by a DJ or venue. Optionally, an event may be both live for a local audience and streamed/recorded for a remote audience. For live events, requests and/or tips via an audience interface generated by Audience Interface Logic 111 may be received from audience members at the live event and/or at remote locations.

In some embodiments, Audience Interface Logic 111 is configured for an audience member to indicate a location of the audience member (or their Audience Device 110A). For example, the audience interface may be configured to access location services (e.g., GPS or WiFi identification) and use this information to provide a location of the audience member. In one embodiment, Audience Interface Logic 111 is configured to confirm that Audience Device 110A is within range of a specific WiFi network in order to establish an audience member's location. For example, a DJ at a wedding may use their DJ Device 120 or Venue Device 125 to broadcast a specific WiFi or Bluetooth address and Audience Interface Logic 111 may use detection of that address on Audience Device 110A to confirm that the Audience Device 110A is near at a specified location. A venue manager may use Venue Device 125 in a similar way to assure that Audience Devices 110 are near a venue. Access to a QR code or pass phrase displayed at a location may be used to confirm location of Audience Device 110A. As is discussed elsewhere herein, the location of an audience member may be used to restrict requests to coming from audience members that are actually at a venue where the DJ is performing.

In some embodiments, Audience Interface Logic 111 is configured for an audience member to request a shoutout and/or send a text message to a DJ. For example, an audience interface may include a text field for an audience member to enter text of should out (e.g., please say “Happy Birthday to Sabrina!”) and optionally further include an input for the audience member to provide a tip to the DJ for the shoutout.

Audience Interface Logic 111 is optionally configured for an audience member to add a comment to a song request made by themselves or by another party, e.g., another audience member, and/or to up-vote a request made by the other party. In a specific example, an audience member may “second” a request made by another audience member as a way to confirm that they agree with the request. The audience member may add a further tip to the request originally made by another audience member.

In some embodiments, Audience Interface Logic 111 is configured to receive QR codes (or data represented thereby), via a generated user interface. For example, the user interface may be configured for users to establish their location using a QR code posted at the location, and/or to identify a DJ or venue that they wish to send requests to using a QR code posted at the location. In a specific example, a DJ may post a QR code, name, passcode, and/or other identifier at a venue, on a website, and/or on their social media. In another example, a QR code or passcode may be included (posted) on an event ticket. An audience member can then use the posted information to send requests, shoutouts, and/or tips to the specific DJ. The QR code may be configured to access an audience interface on Audience Device 110A using Audience Interface Logic 111, the audience interface being configured to perform any of the various functions discussed herein. Such audience interface may be viewed in a mobile application and/or a browser. Identification of a specific DJ or venue is useful in embodiments wherein Server 130 support a plurality of different events (each at a different location and/or with a different DJ) in parallel. In a specific example, Audience Interface Logic 111 includes a web page, optionally accessible via a link represented by QR code.

Optionally, an audience interface generated using Audience Interface Logic 111 is configured for an audience member to communicate with other audience members and/or to display a shoutout. For example, the audience interface may be configured to facilitate messages between audience members located at a specific venue and/or audience members virtually attending a specific event. Communication between audience members at a particular event can be restricted based on location data associated with Audience Devices 110 as discussed elsewhere herein. The audience interface may be configured for an audience member to add a comment to their and/or another's request.

Audience Interface Logic 111 is optionally configured to support a “pop-up” social network among audience members at a specific event. Such a social network may be configured for audience members to share: connections, images, profiles, messages, handles to other social media profiles, personal information, contact information, and/or the like. For example, in some embodiments, Audience Interface Logic 111 is configured to provide access to a social network that is restricted to: audience members at a specific event, audience members at events at a specific location, audience members having attended events by a specific DJ, and/or audience members having a VIP/member status. In some embodiments the ability to connect with other audience members is restricted to audience members (currently or previously) at an event, while the connections made persist past the event.

Audience Interface Logic 111 may be configured to present a promoted song or artist to audience members in one or more ways. For example, a promoted song or artist may be promoted as part of a recommendation list of songs that can be requested, and/or a promoted song may be promoted as a visual and/or audio advertisement presented within the audience user interface generated by Audience Interface Logic 111. Audience Interface Logic 111 is optionally configured to generate an audience interface configured to provide audio to audience members, for example, audio including song snippets of promoted songs and/or songs from a request recommendation list. In alternative embodiments, a song or artist may be promoted by e-mail or text message to Audience Devices 110. For example, a text or MMS message may be sent via WhatsApp, TikTok, Apple Messenger or Facebook/Meta Messenger. This message can include a link to the promoted content, to a website, and/or to a downloadable application, with which the audience member can request the promoted content. Specifically, a text message may be configured for a user to download an application including all or part of Audience Interface Logic 111, and then use an audience user interface generated therewith to request the promoted content. Note that promotions provided using Audience Interface Logic 111 need not be for songs or artists. The promotions May alternatively be for venues, events, DJ, e-commerce stores, and/or other products or services. For example, an audience member that has requested a specific artist may be provided with an advertisement for a concert by that artist. Promotions are optionally targeted to audience members based on the location of the audience member, e.g., as determined using Location Logic 165, songs or artists they have requested, venues they have visited, social network content or connections, text messages they send, and/or other user characteristics known to be used for targeting of advertisements.

Promoted songs and or artists are optionally included in a recommendation list of songs and artists that can be requested. Optionally, the inclusion of the promoted song/artist in the recommendation list is subject to criteria established by the DJ to whom requests would be made. For example, a song to be promoted may be required to meet the criteria established by the DJ to be included in the recommendation list. In some cases, a song that does not meet the characteristics of the current DJ may still be promoted using a visual and/or audio advertisement provided within the audience user interface. A promoted song or artist may be displayed to an audience member as part of a selectable list or may be used in the auto-completion of text. For example, if Cher is a promoted artist, then “Cher” may automatically be displayed in a text entry field when a user types “C.” Typically, a promoted item is indicated as being promoted (i.e., sponsored content). In various embodiments, Audience Interface Logic 111 is configured to present a list of selectable genres to the audience member, to present a list of songs to the audience member, to receive a selection of a song from the list of songs, to add the selected song to a request list, and/or for the audience member to send a tip to the DJ.

In some embodiments, song and/or artists included in the recommendation list is dependent on contents of a playlist of the DJ. This playlist may be established before an event and may be modified during an event. For example, a DJ may plan an event by establishing a list (optionally ordered) of songs to be played and may reorder and/or otherwise change the list in response to the audience's reactions to songs played. Optionally, songs from the playlist are included in the recommendation list. As such, a requested song may be one that the DJ planned to play anyway. Optionally, songs that have been played by the DJ are automatically removed from the recommendation list, for the duration of an event or for a duration of time. Thus, a song that is recently played will not be recommended to be requested.

Audience Interface Logic 111 is optionally configured to generate a user audience interface within which a user can select a DJ and/or to view a DJ profile, and/or can select a venue and/or a profile of a venue. For example, in various embodiments, a user audience interface may be used to browse events at a specific venue, view future and/or past performances (public and/or private) by a selected DJ, to determine which DJs play songs of interest to a prospective audience member, to identify similar DJs, to book DJs, and/or the like. In a specific example, a user may identify a set of favorite songs or artists and then use the user audience interface to identify DJs, venues, and/or events that play those songs. Audience Interface Logic 111 is optionally configured for an audience member to connect with a DJ and/or other audience members via a social network.

Audience Interface Logic 111 is optionally configured to generate a user interface for an audience member to established and/or modify their own audience member profile. This profile may include a history of requested songs or artists, venues or events visited, favorite DJs, and/or the like. For example, an audience member's profile may include a list of DJs and events that have attended. Such audience member profile may also include links to social media profiles or dating apps of the audience member. In a specific example, a profile of an audience member at an event may include a link to the audience member's Tinder or Facebook profiles, and access to that link may be restricted to other audience members at that specific event during the event.

In some embodiments, Audience Interface Logic 111 is configured for an audience member to join a remote and/or virtual event. For example, an audience user interface may be configured for an audience member to remotely view a live-streamed event and send requests to a DJ performing at the event.

In some embodiments, Audience Interface Logic 111 is configured for an audience member to indicate a location of the audience member. For example, the audience member may indicate they are in a particular venue at a specific address. The indication of location May be facilitated by Location Logic (165) discussed elsewhere herein.

In some embodiments, Audience Interface Logic 111 is configured for audience members to communicate with a DJ and/or other audience members. For example, audience members may be able to send text messages to a DJ and/or to other audience members at the same event/venue. Specifically, an audience user interface may be configured for sending text messages to a group limited to DJs or other audience members at a specific geographic location of an event. Examples of such communication may include social media connection requests, photographs, personal notes (text, emojis, images, etc.) to DJs, adding a comment to a song request made by another party, e.g., another audience member, and/or to up-vote a request made by the other party.

In some embodiments, Audience Interface Logic 111 is configured for a user to send their telephone number, name, picture, ticket serial number, and/or other identifying information to Server 130, DJ Device 120, Venue Device 125 or Audience Device 110B. As noted elsewhere herein. This identifying information is optionally used by Request Management Logic 133 to require that requests only come from audience members having a VIP status, present at a particular event, having an event ticket, and/or the like.

In various embodiments, Audience Interface Logic 111 is configured to facilitate uploading of photos from Audience Devices 110 to Server 130. These photos may be used to generate a photo album associated with an event. The photo album may be displayed at the event in near real-time, e.g., on a display screen of Venue Device 125. The photo album May also be accessible via a social media account and/or Audience Interface Logic 111. Optionally, uploaded photos are curated by the DJ, venue owner, and/or an event organizer prior to being made accessible. A DJ, venue, and/or owner of Server 130 may charge for such features.

In one example, to generate one or more photo albums of a wedding, a bridal couple may allow wedding guests to upload photos from their smartphones, e.g., using Audience Interface Logic 111, to a private photo album associated with the wedding. The photos are optionally associated with the event parts and/or songs during which they were taken. Optionally, the uploaded photos are reviewed prior being made viewable by other guests. This review may be performed by the bridal party, by the DJ, and/or a designated third party.

Photo albums are optionally private. For example, a wedding photo album may be private to wedding guests or members of a social network associated with the wedding. A dance party photo album may be private to attendees at that specific party, to followers of a DJ at the party, to an organizer of the party, and/or to an owner of a venue at which the party took place.

Server 130 optionally further includes DJ Interface Logic 121 configured to generate a DJ user interface. DJ Interface Logic 121 is configured for a DJ to interact with other aspects of Entertainment Management System 100. For example, DJ Interface Logic 121 may be configured to present (to a DJ) a DJ user interface including a current playlist, a list of requested songs, the list of requested songs optionally including an amount tipped for each request and/or a number of audience members who have requested each song. DJ Interface Logic 121 may also be configured for communication with Performance Logic 175 or Profile Logic 170 (discussed elsewhere herein). A DJ user interface generated by DJ Interface Logic 121 may be configured for use by a live DJ present at an event, for use by a DJ remote from an event, and/or for use by an AI based virtual DJ. DJ Interface Logic 121 may be configured to communicate with a live DJ or an AI based virtual DJ.

In typical embodiments, DJ Interface Logic 121 is configured for a DJ to accept, reject, and/or archive a song request, and optionally configured for the DJ to comment on a song request. For example, a DJ may view a list of current requests. These requests may be shown in association with their artists, song length, genre, musical key, beats per minute, transition scores, and/or other song information. Each song may also be shown with a respective tip amount, number of requestors, closeness to songs on a current playlist, etc. In a specific example, a requested song may be shown with its title, artist, length, beats per minute, general popularity (e.g., as measure by a song streaming service). Optionally, a song may also be shown with respect to where in the current playlist is could be added. Thus, Request Management Logic 133 (discussed elsewhere herein) may determine that the requested song would fit well between the 3^{rd} and 4^{th} songs on the playlist based on transition scores, and this suggestion may be presented to the DJ. Such a determination may be based on a machine learning system, Request Management Logic 133, Transition Logic 167, and/or other matching song characteristics such as beats per minute. In a specific example, DJ Interface Logic 121 is configured to present a list of requested songs to the DJ, the list of requested songs optionally including an amount tipped for each request and/or a number of audience members who have requested each song.

DJ Interface Logic 121 is optionally configured for a DJ to upload and/or develop their own playlist of songs to be performed at an event. A playlist may be uploaded from an instance of DJ Device 120, a personal computer, and/or a remote music service. The playlist may include songs to be suggested to the audience member as possible requests, and/or the songs of the playlist being the only songs that the audience member may request. DJ Interface Logic 121 is optionally configured for a DJ to designate one or more genres of songs, requests for songs being limited to the designated genres, and/or for the DJ to designate a language of requested songs.

A playlist may be generated directly within a DJ user interface generated using DJ Interface Logic 121. In one example, a DJ can build a playlist by dragging and dropping songs between fields of the DJ user interface. This may involve viewing transition scores and/or listening to snippets of each song, and/or listening to transitions between songs. A playlist May be developed before an event at which it is used and may be stored for use at subsequent events. The DJ user interface is typically further configured for the DJ to modify the playlist before, during or following an event, such modifications including addition of requested songs within specific locations of the current playlist.

When a song request is accepted by a DJ, the song may be inserted into a current playlist at a location designated by the DJ or may automatically be added to the playlist at a position determined by Request Management Logic 133 and/or Transition Logic 167. The position determined by Request Management Logic 133 may be based on any of the song characteristics discussed herein, including transition scores. For example, the song may be placed between two other songs for which the transition between songs would be desirable, e.g., generating a smoot transition, have a similar style, beats per minute, musical key, instrumentation, genre, danceability, etc.

Typically, if an artist is requested by an audience member, DJ Interface Logic 121 is configured to provide the name of the artist and a list of selectable songs by that artist to the DJ. The list of selectable songs may be filtered using Filter Logic 160 and/or selected using Request Management Logic 133. For example, the list of selectable songs may be taken from a recommendation list generated by Request Management Logic 133 using Transition Logic 167. The DJ user interface is optionally configured for the DJ to select and drag a song from the list of selectable songs to a desired or indicated position in the current playlist.

In various embodiments, DJ Interface Logic 121 is configured to provide a DJ user interface that includes a tracking of tips received by the DJ. The tips may be displayed per event, per requester, per song, per artist, etc. The DJ user interface may also display amounts of tips offered to the DJ for yet unaccepted song requests, or shoutouts. In some embodiments, Request Management Logic 133 is configured to recommend songs to be requested based on amounts of tips received for similar songs and/or songs by the same artists. For example, if three songs by a particular artist are associated with desirable tips then, Request Management Logic 133 may add other songs by that artist to the request recommendation list.

DJ Interface Logic 121 is optionally configured for a DJ to manage and/or perform at one or more remote events. For example, a DJ may perform at a live event while streaming (in parallel) to one or more instances of Audience Devices 110 and/or Venue Devices 125. In one example, the Audience Devices 110 may be geographically dispersed, e.g., may belong to audience members who have signed up (and possibly paid) to view the event without regard for the audience members' location. In another example, the event at which a DJ is performing live may be streamed to a remote venue (i.e., to an instance of Venue Device 125) at a specific location remote from the DJ. The DJ may receive requests from more than one event (e.g., an in person event and a remote event) taking place contemporaneously (e.g., at overlapping times).

When an event is streamed to one or more remote locations, Entertainment Management System 100 may be configured for audience members at those locations to send requests to the DJ. Thus, the DJ may perform at and receive tips from multiple locations in parallel (i.e., simultaneously). Location Logic 165 is optionally used to determine a plurality of locations of Audience Devices 110 and Request Management Logic 133 may be configured to only accept requests from a set of designated locations. For example, a DJ may perform an event at a first location and remotely stream that event to two additional locations. In this case, Request Management Logic 133 may be set up to only accept request from these three locations for the duration of the event. The other locations could be, for example, a house party, a club in a different city, etc. In some embodiments, an event is streamed to audience members based on the purchase of a ticket, regardless of where the audience member is actually located. DJ Interface Logic 121 is optionally configured for the DJ to designate locations from which requests may be sent and/or to designate locations at which songs are played. Further, the DJ may choose to play different songs at different locations in parallel (e.g., contemporaneously).

DJ Interface Logic 121 is optionally configured for a DJ to manage a DJ profile. The DJ profile may include information about the DJ such as their performance schedule, booking information, a booking portal, their music, links to past performances, favorite songs, playlists, and/or the like. In some embodiments, a DJ profile is managed by an entity that manages a plurality of DJs. For example, a booking company may manage a group of DJs including their schedules, promotions, billing, etc. In such a case, the DJ's profile may be one of several DJ profiles managed by the booking company. A booking company may have access to an interface generated by DJ Interface Logic 121, but with greater privileges than the managed DJs. A DJ profile may include ratings and audience reviews from audience member/followers. A DJ profile may be configured for a DJ to get insights about their audiences. This may include the most requested songs, tipping patterns, peak request times, audience demographic information, etc. A DJ may suggest new tracks or artists to their audiences via their profile and/or a request recommendation list. A DJ profile may be associated with an e-commerce store.

DJ Interface Logic 121 is optionally configured for a DJ to publish proposed, current or prior playlists, for example, to their social media accounts or DJ profile. Likewise, Audience Interface Logic 111 may be configured for audience members to share their song request with friends or post requests to their social media accounts. Optionally, an audience member May choose to automatically update their social media accounts based on their activity through an audience user interface generated using Audience Interface Logic 111. In some embodiments, DJ Interface Logic 121 is configured for the DJ to automatically post a song or song list to a social media account.

In various embodiments, DJ Interface Logic 121 is configured for a DJ to associate their DJ profile on Server 130 with music services. For example, a DJ may integrate their account with services such as Spotify, Apple Music, etc. Once connected, the DJ may then exchange playlists between their DJ profile and these services, and/or access music through these services. In a specific case, a DJ may use a third-party music service to obtain a requested song and/or information about the requested song. In some embodiments, a DJ may provide playlists to third-party music services, for use by these services. In such embodiments, a user of Spotify could request from Spotify a playlist from a specific DJ.

DJ Interface Logic 121 is optionally configured for a DJ to manage their personal profile. DJ Interface Logic 121 and Request Management Logic 133 may be configured for a DJ to set minimum tip amounts for making a song request or requesting a shoutout. DJ Interface Logic 121 is optionally configured for a DJ to view the audience member or profile thereof. The view of the audience member may be provided by the audience member (e.g., via Audience Interface Logic 111) and/or by a camera located at an event (e.g., a part of Venue Device 125).

A personal profile of a DJ or Audience member may include photos, a username, events and/or DJs attended, songs requested, tips paid, favorite DJs, messages with DJs or other audience members, top fans, event schedules, tickets purchased, reservations at events, song lists, and/or the like. The personal profile of a DJ is optionally part of a social network managed by Social Network Logic 168 (discussed elsewhere herein).

All or part of DJ interface Logic 121 is optionally disposed on DJ Devices 120.

Entertainment Management Logic 100 optionally further includes Venue Interface Logic 126. Venue Interface Logic 126 is configured to generate a venue interface for the owner/manager of a venue to interact with other elements of Entertainment Management System 100 including, for example, Audience Devices and DJ Devices 120. Such venue interface may be configured for a venue owner and/or event organizer to schedule events, sell event tickets, advertise to DJs and/or audience members, offer promotions (e.g., drink/food specials, ticket discounts, etc.) Such promotions may be based on a set of audience members and their activities at a specific event. For example, a venue owner may offer the user of Audience Device 110A a drink discount if they purchase a drink for a user of Audience Device 110B. Likewise, a venue owner may offer an audience member a discount for providing a DJ tip and/or for having a song request played by a DJ. Venue Interface Logic 126 is optionally configured to designate no-play lists. For example, a venue owner or organizer may designated a filter preventing playing of adult content for a family event.

DJ Interface Logic 121 and/or Venue Interface Logic 126 are optionally configured for defining or creating events. For example, a venue owner may use Venue Interface Logic to post performances, schedules, sell and distribute tickets, etc. for in-person or remote events. Audience members may then register, purchase tickets, or engage in other activities associated with these events. In one embodiment, the DJ or venue owner may require that an audience member “check-in” at an event in order to make requests or otherwise access features of Server 130 in relation to the event. DJ Interface Logic 121 and/or Venue Interface Logic 126 may be configured for organizers, venue operators, and/or DJs to communicate with their audiences (e.g., customers).

Server 130 typically includes Transaction Logic 135. Transaction Logic 135 is configured to facilitate financial transactions between audience members and 1) DJs, 2) organizers, and/or 3) Venue managers, using Audience Devices 110, DJ Device 120 and/or Venue Device 125. Transactions using Transaction Logic 135 may be facilitated but payment services, credit cards, Paypal, Venmo, Zelle, CashApp, and/or the like. In some embodiments, Transaction Logic 135 is configured to make payments depending on whether a requested song has actually been played. For example, Transaction Logic 135 may be configured to deduct funds from an audience member's account at a time a request is made. If the request is accepted and the song played, then funds may be transferred into an account of the DJ. If the request is not accepted or played, the funds are optionally transferred to the audience member's account. Performance Logic 175 (discussed elsewhere herein) is optionally configured to determine if a requested song has actually been played. In a specific example, Transaction Logic 135 is configured to accept a credit card payment, to accept a payment made with a payment application, to execute a transaction responsive to a song request being accepted by the DJ, and/or to reject a transaction associated with a rejected song request.

Server 130 typically further includes Request Management Logic 133. Request Management Logic 113 is configured to manage requests from audience members to DJs. This management can include, for example, recommending songs or artists to request, filtering of received requests, maintaining lists of requested songs or artists, determining if a payment is due to a DJ for playing a song, and/or the like. Recommendations of songs to request may be using Playlist Logic 155, Filter Logic 160, Event Logic, Social Network Logic 168, Profile Logic 170, Performance Logic 175, Genre Management Logic 185, etc. made using Audience Interface Logic 111. For example, a recommendation list of songs may include songs from a predetermined playlist, and may be filtered using Filter Logic 160. Songs recently played, as determined by Performance Logic 175, and/or songs from a no play list determined using Event Logic 163 may be removed from the recommendation list. development and use of recommendation lists of songs and/or artists. Filtering of received requests is optionally performed using Filtering Logic (160) as discussed elsewhere herein.

In some embodiments, Request Management Logic 133 is configured to maintain a recommendation list of songs or artists to be requested. Songs or artists on the recommendation list may be presented to audience members via an audience user interface generated by User Interface Logic 111. In some embodiments, the recommendation list is manually provided by the DJ. In this case the DJ may select specific songs and/or artists that can be requested. The recommendation list may or may not include a play list for a specific event or playlists of the DJs that could be used at other events.

In some embodiments, Request Management Logic 133 is configured to generate a recommendation list of songs similar to songs on a DJ's playlist. For example, Request Management Logic 113 may use characteristics of songs on the playlist and automatically generate recommendation lists of songs having similar characteristics. These characteristics may include any combination of: the same or similar artists, the same or similar genre, similar release date (1980s, 1990, 2000s, etc.), similar instrumentation, key mixing, similar key and/or harmonic mixing, similar song duration, harmonic wheel (e.g., circle of 5ths, circle of 4^{th} or Camelot Wheel), danceability, similar energy level, similar beats per minute (BPM), or any other song characteristic.

A Camelot Wheel organizes keys in a way that shows the strong connections between each key. Each segment of the wheel represents one of the 24 available keys, with each key assigned a unique Camelot code following the Mixed in Key notation. The outer ring of the wheel represents major keys, while the inner ring represents minor keys. Using the Camelot Wheel, DJs can easily identify compatible key pairs for harmonic mixing. Moving one step to the left or right on the wheel, or transitioning from the outer ring to the inner ring (or vice versa), allows DJs to find key signatures that work well together. This intuitive system eliminates the need for in-depth music theory knowledge and streamlines the process of arranging mix playlists based on key compatibility.

Uses of a Camelot Wheel include: Relative Keys: Mixing tracks with the same root note but different modes, such as a song in C major (C) with a song in A minor (Am), creates a harmonic match due to the shared root note. This method of key mixing is often straightforward and yields pleasing results. Camelot Wheel Combinations: By moving one step to the left or right on the Camelot Wheel, DJs can find compatible keys. For example, mixing 8B (F# major) with 9B (G #minor) or 7B (E major) will result in melodically pleasing transitions. Fourth or Fifth Interval: Mixing tracks with a perfect fourth or fifth interval between their keys can create harmonically compatible transitions. For instance, mixing a song in D minor (Dm) with a song in G minor (Gm) or vice versa yields pleasing results.”

In a particular example, Request Management Logic 133 may be configured to consider songs to be played in the next 30-60 minutes according to a DJ's playlist and to identify matching songs to include on the recommendation list. The “matching” songs may include those having similar artists, beats per minute, and rhythms. In another example, the “matching” songs are considered to be those found on third party playlists (e.g., Spotify, Apple Music or Pandora) that include the songs of the DJ's playlist. The beats per minute may be considered at the start or end of each song so as to achieve a smooth transition between songs. Optionally, a good match is determined by identification of a smooth transition between songs using Transition Logic 167.

In some embodiment DJ Interface Logic 121 is configured for a DJ to edit recommendation lists generated by Request Management Logic 133. Such editing may occur before the start of a session or during a session as the DJ gets a feel for what the audience wants at that particular time. Likewise, DJ Interface Logic 121 is typically configured for a DJ to generate, import/export, edit and store their own playlists.

The recommendation list managed by Request Management Logic 133 is optionally an ordered list. For example, a DJ may sort the list to put songs he or she would most like to see requested at the top of the list. In some embodiments, songs on the DJs current playlist (for the current event) are automatically placed at the top of the recommendation list, e.g., given the highest priority as a suggestion as a request.

In some embodiments, Request Management Logic 133 includes a trained machine learning system (e.g., an artificial intelligence system) configured to identify and add songs or artists to the recommendation list. The machine learning system may be trained on the success of past request recommendations, their selection by audience members, their song characteristics, and/or DJs playlists. This machine learning system may be configured to receive a current DJs playlist, and even real-time audience feedback, and in response to this information edit (move, add or remove songs) the recommendation list. The real-time audience feedback may be measured by: a manual input from the DJ, activity on audience user interfaces generated using Audience Interface Logic 111, audience noise, audience movement (e.g., as detected using a camera), tip amount, and/or the like. Some embodiments include collecting success data regarding recommended songs, training a machine learning system using the success data, collecting audience information at a live event, and using the collected audience information and the trained machine learning system to modify a recommendation list or a playlist for the live event.

Request Management Logic 133 is optionally configured to manage requests for specific audiences. For example, a recommendation list may be specific to an age group, a location, an event type, explicit or non-explicit language/video, and/or any other category discussed herein. Likewise, machine learning systems included in Request Management Logic 113 may be trained for specific audiences. For example, one machine learning system may be trained for a specific age group, while another machine learning system may be trained for a specific genre and/or event type.

Request Management Logic 133 is optionally configured to only accept requests from specific sources. For example, request may be required to come from Audience Devices 110 at specific locations, from pre-registered audience members, from audience members having a ticket or VIP status, from audience members having a paid account, from audience members included on a pre-established list, from audience members having a status/membership in a social network, and/or the like. In a specific example, perhaps at a wedding or private party, requests may be restricted to come from only registered guests that have provided identifying information such as their name, service username, phone number, etc.

In various embodiments, Request Management Logic 133 is configured to determine the recommendation list of songs (suggested to audience members as being good requests) based on songs available to the DJ to be played. For example, if the DJ is playing songs from a remote streaming service then the recommendation list may be limited to or include songs from that streaming service. Likewise, if a DJ is playing songs locally stored in memory, then the recommendation list may be limited to or include songs stored in the memory.

In some embodiments, Request Management Logic 133 or Playlist Logic 155 are configured to receive request from music promotors. Thus, a music promotor not necessarily at an event may remotely request a sponsored song be played by a DJ. Such request may occur before or during an event.

Transaction logic 135 configured to facilitate the financial transaction between the various parties discussed herein. Such transactions can include tips and/or shares thereof. For example, Transaction Logic 135 may be configured to provide a tip from an audience member to a DJ. Likewise, Transaction Logic 135 may be configured to provide a payment from a music publisher to a DJ in response to the DJ playing a promoted song. This promoted song may be promoted via the request recommendation list and Audience Interface Logic 111, or may be promoted directly to the DJ in a request that the DJ add the song to their playlist during or prior to an event.

In typical embodiments, Transaction Logic 135 is configured to accept a credit card payment, to accept a payment made with a payment application, to execute a transaction responsive to a song request being accepted by the DJ, and/or to reject a transaction associated with a rejected song request. In some embodiments Transaction Logic 135 is configured to divide a tip received from the audience member into multiple parts and to send the multiple parts to different accounts.

Server 130 typically further includes Communication Logic 140. Communication Logic 140 is configured for the various parties to communicate with each other, optionally via Network 115. For example, Communication Logic may be configured to communicate song requests from audience members and/or music promotors to DJ. Such communication can be from Audience Device 110A to DJ Device 120. The Communication can include text messages, structured data (e.g., IP/TCP packets), multimedia messages (MMS), links, audio messages, photos, and/or the like. Elements of Communication Logic 140 may be disposed on any of the devices illustrated in FIG. 1

Server 130 typically further includes Promotion Logic 145. Promotion Logic 145 is configured for promotion of songs, and/or other content. Promotion Logic 145 may include an advertising platform and may insert advertising, for songs or other products and services, into an audience user interface generated by Audience Interface Logic 111. Typically, Promotion Logic 145 and/or Transaction Logic 135 is configured to initiate a financial transaction based on promotion and/or playing of a song.

In a specific example, Promotion Logic 145 is configured to suggest songs to be requested: with a playlist, as an image in the audience interface, as an already requested song, in a list of trending songs, as a text message, in an audience application, with an image of the DJ, with an image provided by the audience member or a venue, with an event schedule, with a DJ profile, with an audience profile, and/or withing a virtual event. Promotion Logic 145 optionally includes and interface (e.g., an API) configured to receive songs to be promoted from a recording artist, music publisher, promotion entity, or advertising agency. The request and/or playing of a promoted song may be detected and logged using Promotion Logic 145 and/or Performance Logic 175. Following such detection, Promotion Logic 175 may initial a financial transaction based on the request and/or playing of the request, e.g., using Transaction Logic 135.

Server 130 typically further includes Playlist Logic 155. Playlist Logic 155 is configured to manage one or more playlists provided by the DJ, a venue, and/or selected by an audience member or an event organizer. For example, Playlist Logic 155 may be configured to receive a set or sequence of songs via a DJ interface generated by DJ Interface Logic 121. These songs may be received as a text file, as links to a song streaming service, as encoded data, as a spreadsheet, and/or the like. In a specific example, a DJ may generate a list of songs using DJ Interface Logic 121 and Transition Logic 167. This can include a drag-and-drop user interface configured to build and manipulate the playlist. The resulting playlist may then be communicated to Performance Logic 175, Song Performance System 176, and/or Request Management Logic 133 as formatted data. In some embodiments, Playlist Logic 155 is configured to use Performance Logic 175 to track which songs on a playlist have been played at a particular event.

Server 130 optionally includes Filter Logic 160. In some embodiments, Filter Logic 160 is configured to filter song requests and/or other communications from the audience member and/or to the DJ. In some embodiments, filter logic is configured to filter song requests or communications from the audience member based on: genre, location, venue, audience membership type, songs previously played, tip amount, song rating (G, PG-13, etc.) (e.g., block request of explicit songs), audience upvotes, language, text content (e.g., block obscenities), number of requests made, and/or a song list. Filter Logic 160 may be configured to filter songs based on any combination of the song criteria discussed herein.

Filter Logic 160 may also be configured to filter communications between DJs, audience members, and/or social media accounts. For example, Filter Logic 160 may be configured to filter messages sent using Communication Logic 140 to remove objectional words and/or offensive content.

In specific examples, Filter Logic 160 can be configured to filter song requests or communications from audience members based on: genre, location, venue, audience membership type, songs previously played, tip amount, song rating (e.g., block request of explicit songs or communication adult content), audience upvotes, language, text content (e.g., block obscenities), photo content (e.g., adult images), number of requests made, a song list, and/or the like. Filter Logic 160 may be configured for a DJ, venue owner or organizer to curate and/or approve filtered content.

Server 130 typically further includes Event Logic 163. Event Logic 163 is configured to facilitate specific types of events. For example, various embodiments of Event Logic 163 may be configured to facilitate weddings, funerals, business events, bar mitzvahs, proms, sporting events, baby showers, anniversaries, birthdays, engagement parties, bachelor/bachelorette parties, holiday parties, networking events, product launches, trade shows, conferences, reunions, karaoke parties, etc. Event Logic 163 is typically configured to gather and/or manage data based on an event type. For example, Event Logic 163 may be configured to receive music requests for specific parts of an event.

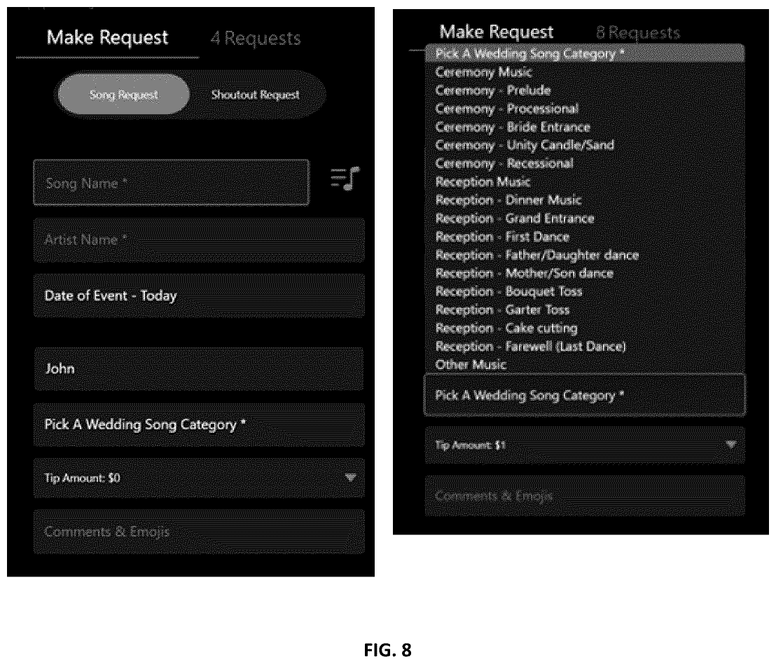

Considering a wedding as an exemplary event. One or more song requests may be made prior to a wedding. A person making the request may use a user interface (discussed further with regard to FIG. 8) to enter a request by Song Name or Artist Name. In various embodiments, the person may make a request based on a snippet of song lyrics and/or any other data that may be used to specify one or more songs. The person is then optionally asked to “Pick A Wedding Song Category.” A list of categories, such as shown in the user interface, may be shown to the requestor. Optionally, one or more of the categories relates to a specific part or phase of a wedding event. For example, a guest may request a song for the Processional of a wedding. Alternative categories may be use for other types of events. Optionally, more than one request may be made, by different requestors, for a specific part of an event. In this case, the wedding party may select which song(s) are to be played at that part of the event. Requests may be voted on by other guests. The wedding party may veto songs, restrict requests to specified song lists, designate a no-play list, designate event categories, restrict access to the request UI, and/or the like.

In various embodiments, Event Logic 163 is further configured for the organizers of an event, e.g., a wedding party, DJ, or venue owner to preview a proposed song list, submit priority requests, link from the event to social media, create photo albums of an event, approve requests, preview (i.e., listen to) songs, and/or the like. For example, a bridal couple May review song requests for the “Bride Entrance” part of a wedding event and select a song to be played based on the requests. In such embodiments, it is the organizer rather than necessarily the DJ that selects which requests to accept and have played.

In some embodiments, Event Logic 163 is configured to gather information about a specific event. Such information may be used by a venue or DJ to customize the event. For example, for a wedding Event Logic 163 may be configured for an organizer to provide information regarding: a number of expected guest, age range of the guests, ages of the organizers, religion of the organizers, favorite music of the organizers, venue type, planned parts/segments of the wedding, cultural background of guests and/or organizers, language of the guests and/or organizers, and/or the like. A DJ may use this information to better develop a playlist for the event.

Event Logic 163 is optionally configured to facilitate uploading of photos of an event using Audience Interface Logic 111, as discussed elsewhere herein.

Server 130 typically further includes Location Logic 165. Location Logic 165 is configured to confirm a location of one or more audience members. For example, Location Logic 165 may be configured to determine the location the audience member using a smartphone or computing device of the audience member, using a venue or event code, using a computing device of a venue, using an IP address of a venue, using a local wireless network, using an image, using a ticket code or invitation, and/or using GPS.

In some embodiments, Location Logic 165 is configured to determine location by listening to live music being played by a DJ at an event. For example, Location Logic 165 May include a smartphone application configured to execute on Audience Device 110A and to record audio of an event, the audio including music played by a DJ. Another part of Location Logic 165 may compare this audio to a song list being played by the DJ, to confirm Audience Device 110A is at the DJ's live event.

Venue Device 125 and/or DJ Device 120 are optionally configured to broadcast Wifi, Bluetooth, and/or other network identifiers. Location Logic 165 may include a smartphone application configured to execute on Audience Device 110A and to detect these signals. Detection of a specific signal may be used by Location Logic 165 to establish locations of Audience Devices 110. Specifically, if a WiFi identifier of a WiFi signal broadcast by DJ Device 120 is detected at Audience Device 110A, then it can be assumed that Audience Device 110A is in the vicinity of DJ Device 120.

In a specific example, Location Logic 165 is configured to determine the location of an audience member using a smartphone or computing device of the audience member (e.g., Audience Device 110A), using a venue or event code, using a computing device of a venue (e.g., Venue Device 125, using an IP address or WiFi address of a venue, using a local wireless network, using an image, and/or using GPS.

In various embodiments of the invention Server 130 further include Transition Logic 167. Transition Logic 167 is configured to facilitate smooth transitions between songs. A smooth transition between songs is one in which the feel of the music does not change abruptly, musicality is maintained, a dance rhythm is maintained, and/or musical atmosphere is preserved. In some embodiments, a smooth transition includes transitions in which a beats per minute (BPM) changes by no more than 2, 5, 7, 10 or 14 beats, or any range therebetween. Production or selection of a smooth transition includes modifying, producing, and/or selecting content to improve smoothness of the transition, relative to a transition that could occur without such consideration. For example, Transition Logic 167 may be configured to fade a first song out while a second (subsequent) song is faded in. Such fading may be based on individual stems (e.g., tracks or other musical parts) of the song. In a specific example, a vocal stem of the first song may be faded before the harmony or rhythm stems and a vocal stem of the second song may be faded in before the rhythm section of the second song.

In some embodiments, Transition Logic 167 is configured to slow and/or accelerate speed of play of a song to smooth a transition between songs. For example, a first song may be slowed slightly just before a transition and a second song may be accelerated slightly to better match the BPM of the songs. The slowing or acceleration may be gradual and may occur over a short beginning or ending segment of a song. For example, the last or first 5, 10, 15 or 20 second, or any range therebetween.

In some embodiments, Transition Logic 167 is configured to provide a musical interlude specifically configured to span a transition between songs. This musical interlude May be a short piece of music, for example, at least 2, 3, 5, 6 8, 10 or 15 seconds, any range between these values, less than 2 seconds or more than 15 seconds. In a specific example, Transition Logic 167 may provide a musical interlude that facilitates the fade from a first song to a subsequent song. The musical interlude may include lyrics, rhythm, harmony, and/or any other musical elements.

In some embodiments, the musical interlude is retrieved from a library of musical interludes, e.g., a database of musical interludes stored in Memory 193. In such embodiments the musical interlude may be selected by Transition Logic 167 so as to generate a smooth transition between songs. The musical interlude, for example, may be configured for a transition between a song of a first BPM and a song of a second BPM. The musical interlude may be indexed by any of the song characteristics discussed. In a specific example, a musical interlude stored in Memory 193 may be indexed (and retrieved) by Transition Logic 167 based on a starting BPM, an ending BPM, starting key, ending key, a vocal characteristic, starting and ending instrumentation, musical instrument ensemble, and/or a genre.

In some embodiments, the musical interlude is generated by Transition Logic 167. For example, the musical interlude used to transition between two songs may be automatically generated using a trained machine learning system (AI) within Transition Logic 167 and/or be derived from an existing song. This artificial intelligence optionally includes a large language model, generative pre-trained transform, and/or neural network. In a specific example, the LLM is trained to take a first and second songs (or parts thereof) as input and to generate a musical interlude configured to bridge a transition between the first and second song in a way that is musically appealing, e.g., smooth, not jarring, danceable, does not create a sudden break or the like. In various embodiments, Transition Logic 167 is configured to generate a musical interlude to be played between two songs in a song list, in order to improve the characteristics of the transaction between the two songs. The musical interlude being generated based on the last few seconds of the first song and the first few seconds of the second song, e.g., the last 2, 3, 5, 6, 8, 10 or 15 seconds, or any range therebetween, or some other time interval. The musical interlude may include a transition in any of the song characteristics used to match songs in a play list. For example, the musical interlude May include a change in BPM, key, instrumentation, and/or vocal style.

A musical interlude provided (e.g., retrieved or generated) by Transition Logic 167 may include two or more stems that are configured to fade in and out with stems of the first and second song. The two or more stems may fade in or out at different times. The musical interlude may include stems of the first and second song.

In some embodiments, Transition Logic 167 is configured to select or alter an order of songs within a song list so as to produce smooth transitions between songs. Such transitions may or may not include a musical interlude. In some embodiments, Transition Logic 167 is configured to determine where in an existing song list a requested song best fits based on transitions between the song and adjacent songs. As discussed elsewhere herein, smooth transitions may be produced by, for example, matching a starting BPM, a ending BPM, starting key, ending key, a vocal characteristic, starting and ending instrumentation, musical instrument ensemble, a genre, danceability, and/or any other song characteristics discussed herein.

In some embodiments, Transition Logic 167 is configured to insert entire songs within a playlist to improve transitions. For example, the transitions between songs X, Y and Z may be better than a transition between songs X and Z. In this case, Transition Logic 167 may suggest addition of song Y to the playlist between songs X and Z. Transition Logic 167 may be configured to insert more than one song to improve transitions between songs. Transition Logic 167 may be configured to reorder songs in a playlist to improve transitions between songs.

Specifically, Transition Logic 167 may be used to add songs to an existing playlist and/or to generate song lists from scratch. For example, a DJ may use Transition Logic 167 to order a set of songs to produce a playlist and then insert requested songs into that playlist. Transition Logic 167 is optionally configured to generate a transition score representative of how smooth a transition is between songs and/or to generate a transition score representative of how well a requested song would fit at any point within a song list. Request Management Logic 133 is optionally configured to used Transition Logic 167 to identify a preferred or best location for a song within a song list based on transition scores at each position; and/or to indicate that a song does not fit well into an existing song list.

In some embodiments, Transition Logic 167 is configured to determine transition scores based on additional characteristics of a playlist. For example, a transition score may be based on an increase or cycling of song “energy” over several songs, on harmonic transitions between a set of songs, an increase in volume, rhythm, and/or beat over several songs, and/or the like.

In some embodiments, Transition Logic 167 is configured to identify a sequence of songs from a song “X” to a song “Y.” For example, if a DJ wishes to play two songs X and Y but the transition between those songs is undesirable, Transition Logic 167 may suggest a song sequence X-A-Y or X-A-B-Y with better transitions scores between the songs. The songs, A and B, may be suggested by Transition Logic 167 using a trained machine learning system and/or using transition score optimization. One, two, three or more songs may be suggested to be placed between songs X and Y.

In some embodiments Transition Logic 167 is configured to determine transition scores purely on matching readily identifiable song characteristics, such as genera, key and BPM. In various embodiments, Transition Logic 167 includes a machine learning system (AI) configured to order songs and/or generate transition scores. Such a machine learning system may be trained using existing DJ generated song lists. The machine learning system may be configured to receive as input: songs and/or song characteristics such as BPM, Key, instrumentation, genre, and/or any of the other song characteristics discussed herein. In one example, Transition Logic 167 is configured to receive audio recordings of songs, to identify the characteristics of the songs, and to generate an ordered list of songs having maximized or preferred transition scores. The ordered list may be generated using the songs themselves and/or any combination of the song characteristics.

In some embodiments, Playlist Logic 155 is configured for a DJ to review (e.g., listen to) song transitions in a playlist, without having to listen to the entire playlist.

Any of the systems and methods discussed herein that are used to add songs to a recommendation list, to add songs to a playlist, to promote a song, and/or to estimate the suitability of playing two songs in succession may be adapted to consider the use of Transition Logic 167 to bridge transitions between songs. This consideration may make two songs, that otherwise would not follow each other well, better candidates for playing one after the other with a musical interlude and/or with a transition score provided by Transition Logic 167 therebetween.

Server 130 optionally further includes Social Network Logic 168, configured to manage social networks among audience members, DJs, organizers, and/or venues. Such social networks may be temporary, e.g., lasting during the time of an event or during the time of an event and for a limited period after the end of the event. As with other social networks, members may build profiles, connect and communicate with each other. However, these social networks are typically also organized around (based on) DJs, events, and/or venues, and are optionally membership restricted based on these criteria. In one example, a social network may be based around a wedding and be limited (membership restricted) to organizers, a DJ, invited guests and other participants in the wedding. In another example, the social network may be associated with a specific DJ and limited to VIP audience members who have attended the DJ's events. A social network managed by Social Network Logic 168 may be limited to audience members, venue owners and DJs who were at a specific venue during certain times.

Social Network Logic 168 is optionally configured to provide social status to members based on their activity. For example, members may increase their status by attending events, giving tips to DJs, making accepted requests, paying for premium membership, etc. An increase in status may result in DJ access, discounts (e.g., drink specials or venue ticket discount tickets), priority requests, an ability to connect with more members of the social network, and/or the like. Social Network Logic 168 is optionally configured to highlight members of higher status, such as members who have given the most tips, and/or to manage competitions between members to give the most DJ tips. In various embodiment, membership in a social network managed by Social Network Logic 168 requires attendance at an event, making a request, and/or a payment of a tip to a DJ.

In some embodiments, Social Network Logic 168 is configured to manage photos. These photos may or may not be associated with specific social media accounts. For example, Social Network Logic 168 may be configured to receive photos from audience members or other participants at an event, and to place these photos in a virtual photo album associated with the event. The photos may be associated with specific requests, audience members, songs, locations, venues, and/or the like. In some embodiments the photos are approved by an organizer and/or displayed at an event in real-time. For example, a photo may be displayed to an audience on display device included in Venue Device 125.

Social Network Logic 168 is optionally configured for members to send each other event related messages or items. For example, a member may purchase a drink or a flower for another member, a member may pay for a request to be made by another member, a member may pay for a ticket to another member, a member may (temporarily) share their VIP stats (and benefits) with another member, and/or the like. Such purchase or payment May be made with currency and/or social status within the network. A DJ may choose to invite members of a DJ, event and/or venue based social network to join (perhaps automatically) other social networks associated with the DJ. Membership in a social network managed by Social Network Logic 168 may require installation of an application on Audience Devices 110, and part of Social Network Logic 168 may be included in such an application.

Social Network Logic 168 is optionally configured to manage an audience member's membership in a plurality of social networks. For example, a first social network based on a first DJ, a second social network based on a second DJ, a social network based on a venue and a social network based on a specific wedding event.

Server 130 typically further includes Profile Logic 170. Profile Logic 170 is configured to manage profiles of DJs, venues, organizers, and/or audience members. Such profiles may include information such as found in other social media profiles. In addition, such profiles may include a history of events attended, a history of DJs seen, a history of tips paid, a history of songs requested, and/or the like. A profile may also include a social status based on such activities, as discussed further elsewhere herein.

Server 130 typically further includes Performance Logic 175. Performance Logic 175 is configured for a DJ to control and communicate with a song performance system, such as Song Performance System 176. For example, Performance Logic 175 may be configured to upload one or more songs from a playlist from the DJ's profile to a Song Performance System 176. Performance Logic 175 is optionally also configured to determine when a song has been played and to report that event to Server 130. For example, Performance Logi 175 may be configured to automatically detect when a (requested) song is performed and based on this event a tip may be provided to the DJ using Transaction Logic 135.

Server 130 optionally further includes Song Performance System 176 includes a DJ play system configured to play songs and/or videos. Song Performance System 176 may include a commercial sound system used by DJs. Examples include: Pioneer DJ DDJ-FLX6, Numark Party Mix II-DJ controller, Hercules DJJ Contol Inputse 500, etc. Song Performance System 176 may include a physical DJ interface, microphones, speakers, lighting, and/or the like.

Server 130 typically further includes Genre Management Logic 185. Genre Management Logic 185 is configured for: accessing information regarding a song, a DJ to select one or more Genre of songs that may be requested, and/or to generate a ranking of songs (e.g., a ranked list of trending songs). In a specific example, Genre Management Logic 185 may be used with Request Management Logic 133 to determine a request recommendation list, when a DJ has limited requests to one or more specific genres. In this case, Genre Management Logic 185 is used to assure that songs on the recommendation list are in the specific genres.

Karaoke Logic 187 is configured to manage song requests in a Karaoke mode.

Server 130 typically further includes an I/O 190. I/O 190 is configured for communication between elements of Server 130, Audience Devices 110, DJ Devices 120, Venue Devices 125, third party music services, social media accounts, and/or other systems, optionally via Network 115. I/O 190 may include communication hardware such as modems, router, WiFi devices, RFID devices, Bluetooth devices, cellular radios, and/or the like. I/O 190 is optionally configured to communicate using WiFi, cellular and/or internet standards. I/O 190 optionally includes a camera configured to read QR codes or an RFID reader configured to read RFID tags.

Server 130 typically further includes Memory 193. Memory 193 is configured to store any of the information discussed herein, such as DJ and Audience profiles, recommendation lists, playlists, tip amounts, tip transaction information, photos, social network connections, financial transactions, etc. Memory 193 optionally includes database management systems and/or data structures specifically configured to store such data. Memory 193 may be distributed among a plurality of devices including Server 130, Audience Devices 110, DJ Devices 120, and/or Venue Devices 125.

Server 130 typically further includes one or more Processor 195. Processor 195 is configured to execute computing instructions, for example, any combination of the logic discussed herein. Processor 190 can be digital, analog, electronic, optical, and/or quantum. In a specific example, Server 130 includes a first Processor 195 including circuits configured to execute Request Management Logic 133 and a second Processor 195 including any of the machine learning systems discussed herein.

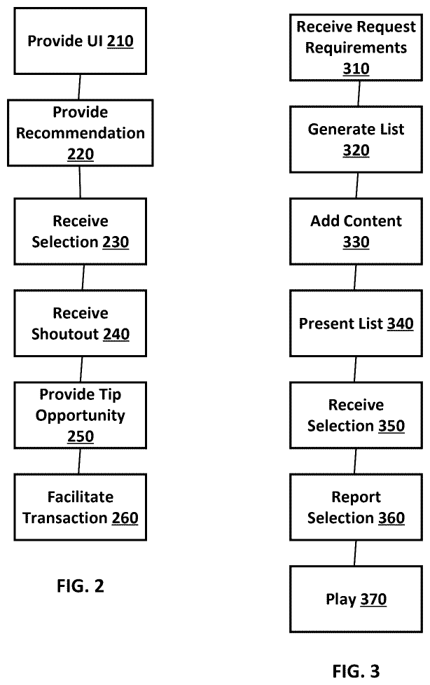

FIG. 2 illustrates methods of performing a financial transaction between a DJ and an audience member, according to various embodiments of the invention. These methods optionally make use of embodiments of the system illustrated in FIG. 1. For example, the financial transactions may be facilitated by Transaction Logic 135, Audience Interface Logic 111, and/or DJ Interface logic. The financial transactions may also involve venue owners, music promoters, and/or an owner of Server 130. While the discussion of FIG. 2 is focused on interactions regarding songs, the methods may be adapted to any multimedia content.

In a Provide UI Step 210 a user interface is provided to an audience member, optionally using Audience Interface Logic 111. As discussed elsewhere herein, this may be accomplished using a QR code, an RFID signal, a mobile application, a universal resource locator (URL/link), and/or the like. The provided user interface may include any of the functionality discussed herein with regard to Audience Interface Logic 111. The user interface is optionally provided via Network 115.

In an optional Provide Recommendation Step 220 a recommendation list is provide to the audience member. Provide Recommendation Step 220 optionally includes use of Communication Logic 140. The provided recommendation list may include songs, artists, and/or genres, and is intended to suggest, but not necessarily require, that requests come from the recommendation list. The recommendation list may include sponsored or promoted songs.

In a Receive Selection Step 230 a request is received from the audience member. This request may be for a song included in the recommendation list or may be a song otherwise suggested by the audience member. The request is typically received from one of Audience Devices 110 using Communication Logic 140. The request may be received by a DJ via Network 115 and Server 130. For example, the request may be managed by Request Management Logic 113 and filtered by Filter Logic 160 before being presented to a DJ using DJ Interface Logic 121. The request may include information regarding the audience member. For example, the request may include a location of the audience member, an audience member's VIP status, prior tips provided by the audience member, a number of requests made by the audience member, a ticket price paid by the audience member, an identity of the audience member, an age of the audience member, a gender of the audience member, a social network membership of the audience member, a social media connection of the audience member, and/or any other characteristic of the audience member or their profile.

In an optional Receive Shoutout Step 240 a request for a shoutout from the audience member via the audience user interface, and providing the request for a shoutout to the DJ. Again, a shoutout request may be managed by Request Management Logic 113 and filtered by Filter Logic 160 before being presented to a DJ using DJ Interface Logic 121. A typical shoutout may include a request to wish someone happy birthday or other acknowledgement.

In a Provide Tip Opportunity Step 250 the audience member is provided with an opportunity to provide a tip associated with the request for a song or the request for a shoutout. This tip is to be sent, at least in part to the DJ. The opportunity may also include an opportunity to provide a comment associated with the request. For example, a requestor May provide a comment saying that the requested song is the song that was playing when they met their partner.

In a Facilitate Transaction Step 260 a financial transaction including a tip provided by the audience member is facilitated. For example, a tip provided by the audience member may be deducted from an account of the audience member and then added to an account of the DJ. Other parties, such as a venue owner, event organizer, and/or owner of Server 130 may receive a fraction of the tip. In some embodiments, the financial transaction includes a payment from a song promotor to the DJ and/or to an owner of Server 130. The financial transaction may also be dependent on acceptance of the request by the DJ and/or actual playing of the song by the DJ as determined by, for example, Performance Logic 175. Facilitate Transaction Step 260 is optionally performed using Transaction Logic 135.

FIG. 3 illustrates methods of promoting entertainment content, according to various embodiments of the invention. This method may be used by artists, musicians, film makers, content publishers, and/or content promotors to promote specific videos, songs, albums, actors, musicians, and/or artists. The method may also be applied to other types of entertainment. Promotional content may be provided to audience members and or DJs via methods other than those illustrated in FIG. 3. For example, banner advertisements may be placed in audience or DJ interfaces generated by Audience Interface Logic 111 or DJ Interface Logic 121, respectively.

In an optional Receive Request Requirements Step 310 request requirements are received from a DJ, the request requirements including criteria for songs, artists, and/or genres. For example, a DJ may specify particular songs, artists, genres to be allowed or disallowed in requests. The DJ may specify information based on audience characteristics (gender, age, culture, etc.), venue characteristics (Jazz club, wedding parlor, location, etc.), and/or event type (rave, birthday, funeral, etc.).

In a Generate List Step 320 a playlist and/or a request recommendation list is generated, optionally using any requirements received in Receive Request Requirements Sep 310. The lists may be generated using, for example, Playlist Logic 155, Request Management Logic 133, Filter Logic 160, Location Logic 165, Social Network Logic 168, etc. In a specific example, a playlist is generated using Playlist Logic 155 in an interactive process with a DJ. Following generation of the playlist, a request recommendation list is generated using Request Management Logic 133. The recommendation list may have content in common with the playlist.

In an Add Content Step 330 promotional content is added to the request recommendation list generated in Generate List Step 320. For example, a promoted song May be added to the top of the recommendation list or an advertisement for the promoted song may be placed beside the recommendation list. In Add Content Step 330, the promoted song may be selected from a plurality of promoted songs based on how well the promoted song would fit within existing playlist (e.g., as represented by a transition score calculated by Transition Logic 167). The promoted song may also be selected based on characteristics of the audience, event, and/or venue, and/or based on the requirements selected by the DJ in Receive Request Requirements Step 310. The selection of the promoted song may be based on revenue offered for promotion of the song and may be made using Promotion Logic 145 or other advertisement placement system.

In a Present List Step 340 the promoted content is presented to an audience member, optionally via an audience interface generated using Audience Interface Logic 111. Optionally, the promoted content includes an indication that it is promoted, such as a “sponsored” label.

In a Receive Selection Step 350 a selection of a song, artist, and/or genre is received from the audience member. The selection may include the promoted content. The selection may include a tip offered by the audience member to the DJ.

In a Report Selection Step 360, the select received in Receive Selection Step 150 is reported to the DJ as a request. Characteristics of the Audience member and the tip may also reported to the DJ. For example, The DJ may receive the name of a requested song, a photo of the audience member, a location of the audience member, a tip amount, a number of audience members who have upvoted the request, a transition score and possible insertion point for the song in the current playlist, a social network status of the audience member, a promotional value of playing the song (if promoted), and/or the like.

In an optional Play Song Step 370, the song request may be accepted, and the song played by the DJ. This may result in a tip and/or promotional fee being paid to the DJ, e.g., using Transaction Logic 135.

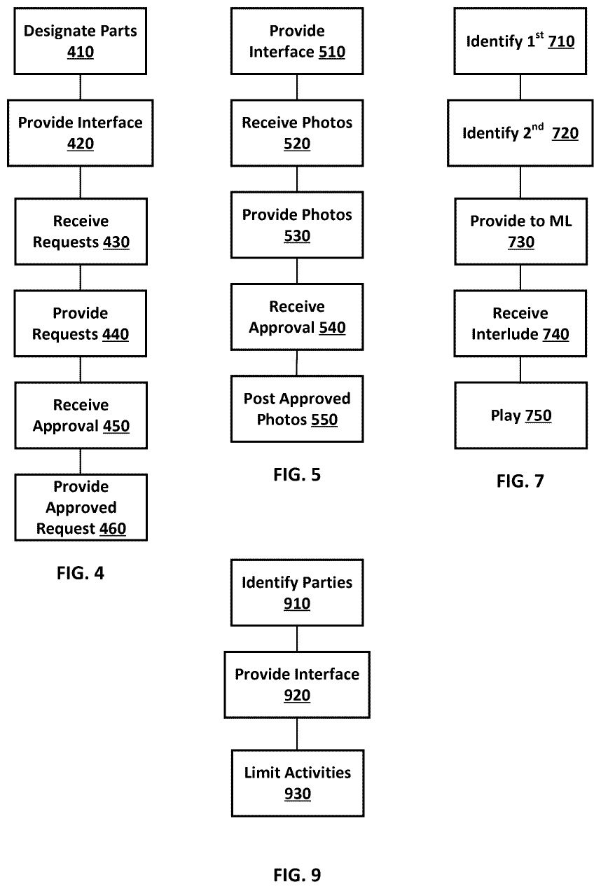

FIG. 4 illustrates methods of managing an event, according to various embodiments. As noted elsewhere herein Server 130 may be used to facilitate a wide range of event types.

In a Designate Parts Step 410 parts of an event are designated. This may be accomplished by first designating an event type and then selecting parts of an event from a template associated with the designated event type. FIG. 8 illustrates an example of parts of an event. In some embodiments, Designate Parts Step 410 includes merely selecting an event type pre-associated with specific parts. Designate Parts Step 410 is optionally performed using Event Logic 163.

In a Provide Interface Step 420, an audience interface, optionally generated using Audience Interface Logic 111, is provided to participants in the event. The participants can include organizers and/or audience members. The audience interface is configured for participants in the event to request songs, optionally in association with the parts of the event designated in Designate Parts Step 410. For example, the user interface may be configured for an audience member to may a request for a first song for a wedding processional and a request for a second song for a wedding toast. The audience interface is optionally provided to multiple participants.

In a Receive Requests Step 430, requests provided by the participants are received, for example, by Server 130. The received requests may include comments, tips, promotional content, and or other features associated with a request as discussed elsewhere herein.

In an optional Provide Requests Step 440, the received requests are provided to an organizer of an event. For example, for a wedding, the requests and the parts of the wedding they are each associated with may be provided to a bridal couple or their designated agent.

In an optional Receive Approval Step 450, approval and/or selection of the provided requests are received from the organizer. For example, if more than one request has been made for a specific part of the wedding, the organizer may select a subset of the requests. The organizer may also disapprove of requests they do not like. Provide Requests Sep 440 and Receive Approval Step 450 are optionally in embodiments were approvals are not required.

In a Provide Approved Request Step 460, the optionally approved requests are provided to a DJ for the event. Note that the DJ may be a party other than the organizer. The DJ may then choose to add the requests to a playlist for the event.

FIG. 5 illustrates methods of distributing photographs, according to various embodiments. The photographs and/or the distribution thereof are optionally associated with a specific event. The distribution may occur using the audience interfaces discussed herein. The distribution of photos is optionally performed using Social Network Logic 168 and/or separate photo logic (not shown).

In a Provide Interface Step 510 an audience interface to participants in an event, the audience interface being configured for the participants to upload photos of the event.

In a Receive Photos Step 520, photos are received from participants in the event. As with requests, the receipt of photos may be dependent on a location of the participants, their social network status, tips, and/or other factors discussed herein. In some embodiments, the receipt of a photo is associated with a tip for including the photo in an album. Photos may further include promoted content, e.g., an advertisement for a song selected using Promotion Logic 145. A photo is optionally associated with a content request.

In an optional Provide Photos Step 520 the photos are provided to an organizer of the event. In an Receive Approval Step 540 approval of one or more of the photos is received from the organizer of the event. Provide Photos Step 520 and Receive Approval Step 540 are optional in embodiments in which approval is not required, and may be accomplished using the various interfaces discussed herein.

In a Post Approved Photos Step 550 the optionally approved photos are posted to an album associated with the event. This album is optionally managed using Social Network Logic 168 and access to the album is optionally restricted to participants in the event and/or invitation. The participants are optionally limited to invited guests or audience members verified as being located at a predetermined location and/or who have purchased a ticket.

In some embodiments, posted photos are displayed at an event in real-time. For example.

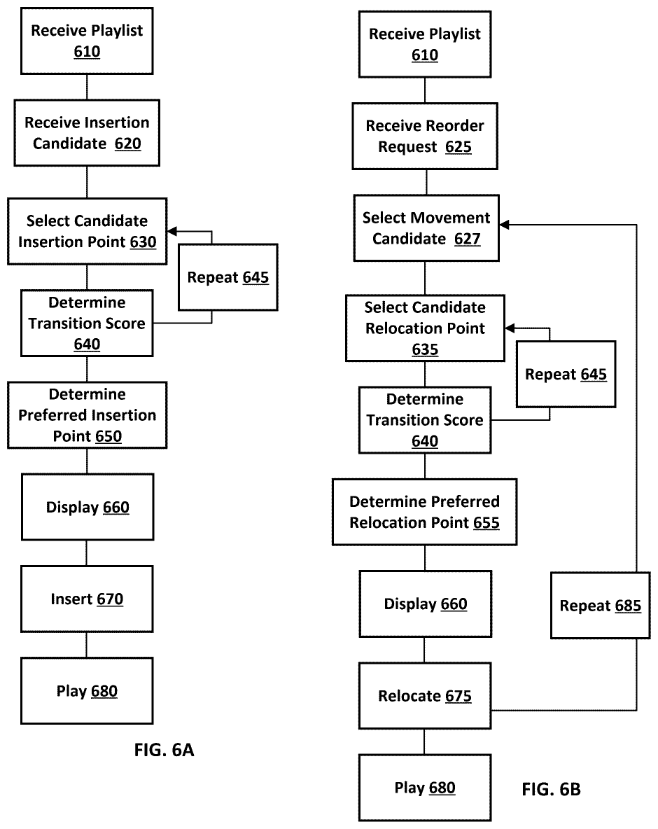

FIGS. 6A and 6B illustrate methods of generating a playlist including smooth transitions between songs, according to various embodiments. In FIG. 6A the methods are related to adding an additional song to an existing play list and in FIG. 6B the methods are related to reordering an existing playlist. These two methods are optionally used together to optimize playlists. For example, a DJ may use the methods of FIG. 6B to improve or optimize the sequence of songs in a group of songs. A requested song may then be added to the sequence of songs using the methods of FIG. 6A. A DJ may consider transition scores determined during these methods to build playlists and/or determine whether or not to accept requests. Addition of a song to a playlist can include the methods of FIG. 6A for insertion of the song followed by a reordering of the updated playlist using methods of claim 6B.

Referring to FIG. 6A, in a Receive Playlist Step 610 a playlist including a sequence of song is received. The received playlist may be have been generated using an artificial intelligence system, generated manually by a DJ, received from a third party, and/or retrieved from a local storage. In some embodiments Receive Playlist Step 610 includes searching for and receiving a playlist from a library of playlists. Such search may be based on event type, genre, and/or any of the other song related categories discussed herein.

In a Receive Insertion Candidate Step 620 an insertion candidate song for addition to the sequence of songs is received. The insertion candidate may be a sponsored song and or a requested song. For example, the insertion candidate may be received via an audience user interface generated using Audience Interface Logic 111, or received from a song promotor.

In a Select Candidate Insertion Point Step 630 a candidate insertion point within the playlist (e.g., sequence of songs) is selected. The candidate insertion point is typically one of a plurality of possible insertion points within the playlist.

In a Determine Transition Score Step 640 a transition score for insertion of the insertion candidate song at the candidate insertion point is determined. The transition score is optionally calculated using Transition Logic 167. The transition score is typically representative of a smoothness of a transitions between the insertion candidate and one or two songs adjacent to the candidate insertion point. Optionally, Determine Transition Score Step 640 includes consideration of placement of a musical interlude or one or more additional songs between songs in the determination of possible transition scores.

In a Repeat Step 645 the steps of selecting a candidate insertion point (Select Candidate Insertion Point Step 630) and determining a transition score (Determine Transition Score Step 640) are repeated. They are repeated at an additional candidate insertion point among the plurality of possible insertion points, resulting in a plurality of transition scores each associated with a candidate insertion point. In a typical example, these steps are repeated for many or all possible insertion points in the playlist. Optionally the repetitions are stopped when a insertion point with transition scores below a predetermined lever is identified. Optionally, the first insertion report tried is the first, second, third, fourth, fifth or otherwise early un-played insertion point in the playlist. In some embodiments, only the first 5, 10 or 20 insertion points are tried.

In a Determine Preferred Insertion Point Step 650 a preferred insertion point from among the plurality of tested possible insertion points is determined. This determination is optionally based on the determined (plurality of) transition scores determined in Determine Transition Score Step 640.

In a Display Step 660 the preferred insertion point and/or an associated transition score for the preferred insertion point is displayed to the DJ, optionally on DJ Device 120 using DJ Interface Logic 121. In one example, Display Step 660 includes showing the DJ part of the current playlist and a marking of where the insertion candidate could be placed. The names of the songs and associated one or more transition scores may also be displayed. Optionally, several alternative insertion points and associated transition scores are displayed. The DJ may then reject or accept insertion at a particular insertion point within the playlist.

In an Insert Step 670 the insertion candidate is inserted at the preferred insertion point. Insert Step 670 may include addition of musical interludes between songs and/or the insertion of additional songs to improve transition scores. Insertion of a song into the playlist may constitute acceptance of a request received from an audience member or music promotor.

In an optional Play Step 680, the playlist including the insertion candidate is played to an audience. Playing of the insertion candidate may result in payment of a tip to the DJ using Transaction Logic 135. Playing of the song is optionally tracked using Performance Logic 175.

FIG. 6B illustrates methods of reordering a playlist including smooth transitions between a sequence of songs. These methods are optionally performed using Server 130. Optionally, the reordering is performed during an event on an un-played part of a playlist. The method starts with (a) Receive Playlist Step 610, discussed elsewhere herein.

In a (b) Receive Reorder Request Step 625 a reorder request is received. The reorder request is a request to reorder the playlist to improve smoothness of transitions between the songs in the playlist. The reorder request may be received from a DJ via a DJ interface generated using DJ Interface Logic 121. The reorder request may be applied to all or a subset of the playlist received in Receive Playlist Step 610.

In a (c) Select Movement Candidate Step 627 a movement candidate is selected from among the songs of the playlist. This movement candidate may be a first, second, third, etc. movement candidate depending on how many times Select Movement Candidate Step 627 is repeated. In some cases, the first movement candidate is the first song in the playlist and the second movement candidate is the second song in the playlist, etc.

In a (d) Select Candidate Relocation Point Step 635 a candidate relocation point within the sequence of songs is selected. The candidate relocation point is typically one of a plurality of possible relocation points within the playlist.

In (e) Determine Transition Score Step 640 a transition score for relocation of the relocation candidate song at the candidate relocation point is determined. The transition score representing a smoothness of a transitions between the current relocation candidate and one or two songs adjacent to the current candidate relocation point. Optionally, the determined transition score is adjusted for a transition score for the movement candidate at its original position in the playlist. For example, if the movement results in an overall improvement in transition score, then a positive transition score change could be determined, and if the movement results in an overall reduction in transition score then a negative transition score change could be determined.

In (f) Repeat Step 645 (d) Select Relocation Point Step 635 and (e) Determine Transition Score Step 640 are repeated for the current movement candidate at an additional candidate relocation point among the plurality of possible relocation points. These steps are optionally repeated for all the possible relocation points within the playlist. The repetition resulting in a plurality of transition scores (or transition score changes) each associated with a candidate relocation point.

In a (g) Determine Preferred Relocation Point Step 655 a preferred relocation point, from among the plurality of possible relocation points, is determined. Typically, this determination is based on the determined plurality of transition scores and/or transition score changes.

In an optional (h) Display Step 660 the preferred relocation point for the current movement candidate is displayed to the DJ. The preferred location point is optionally displayed along with an associated transition score or transition score change for the preferred relocation point. Further details of Display Step 660 are discussed elsewhere herein.

In a (i) Relocate Step 675 the current movement candidate is relocated to the preferred relocation point to produce a reordered playlist to improve transitions between the sequence of songs.

In an optional (j) Repeat Step 685 (c) Select Movement Candidate Step 627 through (i) Relocate Step 675 are repeated using one or more additional movement candidates. Repeat Step 685 is optionally repeated until all possible movement candidates have be considered for movement to further reorder the playlist and improve transitions between songs. Alternatively, a DJ may apply the methods of FIG. 6B to a subset of a playlist to improve transitions within that subset.

In an optional (k) Play Step 680, the reordered playlist is used to present the songs therein to an audience. For example, at a live and/or virtual event.

FIG. 7 illustrates methods of transitioning between songs using a musical interlude, according to various embodiments. Typically, the musical interlude is configured to improve the smoothness of the transitions. The musical interlude optionally includes an audio segment generated by a trained machine learning system and/or an audio segment from an existing song. The musical interlude is optionally derived, at least in part, from the two songs at a transition. In some embodiments, the musical interlude includes one or more entire songs placed between songs at a transition point. The methods of FIG. 7 are optionally performed using Transition Logic 167. The methods of FIG. 8 are optionally performed using Server 130 and specifical using Transition Logic 167.

In an Identify First Step 710 a first song of the playlist and first characteristics of the first song at an end of the first song are identified.

In an Identify Second Step 720 a second song of the playlist and second characteristics of the second song at a beginning of the second song are identified. The first and second songs of the playlist being in sequential order in the playlist and “first” and “second” are used to identify different songs of a playlist, not to imply specific locations within the playlist.

In an Provide to ML Step 730 the first characteristics and the second characteristics are provided to a machine learning system. The machine learning system is typically trained to generate a musical interlude configured to bridge a transition between the first song and the second song, the generation being based at least in part on the first characteristics and the second characteristics.

In a Receive Interlude Step 740 the musical interlude or a link thereto is received from the machine learning system. The musical interlude may include audio produced by the machine learning system and/or a segment of an existing song (optionally other than the first and second songs) identified using the machine learning system. For example, the musical interlude may include segments of the first and second songs intermingled and/or altered by the machine learning system, new music produced by the machine learning system, a snippet of a third song that makes a good musical interlude for the first and second songs. In some embodiments, the musical interlude is retrieved from a library of musical interludes based on an output of the machine learning system. The musical interlude may be short, e.g., 1, 2 5, 10 or 20 seconds, or any range therebetween. Or, the musical interlude may be longer, e.g., including an entire song identified by the machine learning system.

In an optional Play Step 750 the first song, the musical interlude and the second song are played in sequential order to an audience.

FIG. 8 illustrates user interfaces configured to access Event Logic 163, according to various embodiments of the invention. Thes interfaces include fields for an audience member to request a song for an event, e.g., a wedding, and to associate the request with a specific part of the wedding, e.g., “Ceremony-Processional” or “Reception-First Dance.” The interfaces further include fields to designate a tip amount. The user interfaces illustrate in FIG. are optionally generated using Audience Interface Logic 111.

FIG. 9 illustrates a method of establishing a social network, according to various embodiments of the invention. These methods are distinguished by being based on a specific event, DJ, and/or venue. For example, a social network may be temporary and/or based around a specific event, such as a live DJ performance at a venue. Such a social network may expire at a predetermined time after the event and may be limited to audience members and other participants at the event. Other social networks may be more permanent. For example, a social network based on a particular DJ may last for as long as the DJ has a license to use elements of Server 130. The methods illustrated by FIG. 9 are optionally performed using Social Network Logic 168.

In an Identify Parties Step 910 the parties at an event are identified. These parties can include, for example, audience members, venue employees, organizers, and/or other participants. They may be identified using an Audience Interface Logic 111, a ticket code, a QR code, Location Logic 165, and/or any other means for identifying a participant discussed herein.

In a Provide Interface Step 920 an audience interface in which attendees of the event can connect to each other on a membership limited social network is provided. This interface may also be configured to provide tips to the DJ. The interface may include features configured for participants to connect with each other on other social networks such as TikTok, Facebook, WhatsApp, Instagram, Snapchat, etc.

In an optional Limit Activities Step 930, one or more features of the social network are limited. These features can include, for example, limiting an amount of time during which event participants can connect on the social network, limiting an amount of time connections on the social network will last, limiting membership in the social network to only participants at a specific event, at a specific venue, who have tipped for a request, who have made a request, who have a VIP status, who have seen a particular DJ live, and/or the like. The membership in the social network is optionally limited to invited guests or audience members verified as being located at a predetermined location.

In a specific example, membership in the social network is limited in membership to event participants, e.g., audience members, venue owners and DJs who were at a specific venue during certain times. The participants may make connections with each other only during and/or shortly after the event. These connections may last past the event (e.g., be persistent) until they are cancelled by one of the parties in each connection. In another example, the interface provided in Provide Interface Step 920 may be configured for participants to connect with each other via one or more of the third-party social networks discussed herein, but the ability to connect may be limited in time (e.g., during an event) and/or by any of the other limiting factors discussed herein.

The social network may include features of legacy social networks such as an ability to share messages and photos. The social network may further include features associated with events, such as the ability to discuss and/or add tips to specific requests, and/or features to engage with a venue, e.g., buy tickets, buy drinks, buy a drink for a social network connection, etc.

Several embodiments are specifically illustrated and/or described herein. However, it will be appreciated that modifications and variations are covered by the above teachings and within the scope of the appended claims without departing from the spirit and intended scope thereof. For example, although “songs” are discussed herein by way of example, the systems and methods described may be used for any type of entertainment or media, such as videos. The systems and methods disclosed herein are optionally applied to streaming services, recorded events, and/or events DJ′ed by an AI. The systems and methods disclosed herein are optionally applied to silent parties.

The embodiments discussed herein are illustrative of the present invention. As these embodiments of the present invention are described with reference to illustrations, various modifications or adaptations of the methods and or specific structures described May become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated.

Computing systems and/or logic referred to herein can comprise an integrated circuit, a microprocessor, a personal computer, a server, a distributed computing system, a quantum computing system, a communication device, a network device, or the like, and various combinations of the same. A computing system or logic may also comprise volatile and/or non-volatile memory (e.g., Memory 193) such as random access memory (RAM), dynamic random access memory (DRAM), static random access memory (SRAM), magnetic media, optical media, nano-media, a hard drive, a compact disk, a digital versatile disc (DVD), optical circuits, and/or other devices configured for storing analog or digital information in a non-transient manner, such as in a database. A computer-readable medium, as used herein, expressly excludes paper. Computer-implemented steps of the methods noted herein can comprise a set of instructions stored on a computer-readable medium that when executed cause the computing system to perform the steps. A computing system programmed to perform particular functions pursuant to instructions from program software is a special purpose computing system for performing those particular functions. Data that is manipulated by a special purpose computing system while performing those particular functions is at least electronically saved in buffers of the computing system, physically changing the special purpose computing system from one state to the next with each change to the stored data.

The “logic” discussed herein is explicitly defined to include hardware, firmware or software stored on a non-transient computer readable medium, or any combinations thereof. This logic may be implemented in an electronic and/or digital device (e.g., a circuit) to produce a special purpose computing system. Any of the systems discussed herein optionally include a microprocessor, including electronic and/or optical circuits, configured to execute any combination of the logic discussed herein. The methods discussed herein optionally include execution of the logic by said microprocessor.

1. An entertainment management system comprising:
audience interface logic configured to present an audience user interface, the audience user interface being configured for an audience member to enter a song request and to initiate a financial transaction including a payment to a DJ;
request management logic configured to manage the song request, the management including providing suggestions of songs to request to the audience member.
transaction logic configured to facilitate the financial transaction;
communication logic configured to communicate the song request to the DJ; and
DJ interface logic configured to present the song request to the DJ.

2. (canceled)

3. (canceled)

4.-9. (canceled)

10. The system of claim 1, further comprising promotion logic configured to suggest a song to the audience member via the audience user interface, the suggestion of the song including a suggestion that the audience member request the song.

11. (canceled)

12. The system of claim 1, further comprising filter logic configured to filter song requests and/or other communications from the audience member and/or to the DJ.

13. The system of claim 1, further comprising location logic configured to confirm a location of the audience member.

14-19. (canceled)

20. The system of claim 1, wherein the audience interface logic is configured to present a song to the audience member, the presented song being a song to request and being on a playlist provided by the DJ.

21. (canceled)

22. The system of claim 1, wherein the audience interface logic is configured to present a list of songs to the audience member, to receive a selection of a song from the list of songs from the audience member, to add the selected song to a request list, and for the audience member to send a tip to the DJ.

23-24. (canceled)

25. The system of claim 1, wherein the audience interface logic is configured for the audience member to add a comment to a song request made by another party, to up-vote the song request made by the other party, or to add a tip to the song request made by another party.

26. (canceled)

27. The system of claim 1, wherein the transaction logic is configured to execute a transaction responsive to a song request being accepted by the DJ, and to reject a transaction associated with a rejected song request.

28-30. (canceled)

31. The system of claim 1, wherein the DJ interface logic is configured to present a list of requested songs to the DJ, the list of requested songs including an amount tipped for each request or a number of audience members who have requested each song.

32. (canceled)

33. The system of claim 1, wherein the DJ interface logic is configured for the DJ to reject the song request and reject a tip associated with the song request.

34-38. (canceled)

39. The system of claim 1, wherein the DJ interface logic is configured for the DJ to designate locations from which the song request may be sent.

40-42. (canceled)

43. The system of claim 1, further comprising promotion logic configured to provide advertisements promoting specific songs or artists to the audience member.

44-46. (canceled)

47. The system or method of claim 13, wherein the location logic is configured to determine the location the audience member using a smartphone or computing device of the audience member.

48-51. (canceled)

52. The system of claim 1, wherein the DJ interface logic is configured to provide the DJ with a beats-per-minute and musical key of the song request.

53-56. (canceled)

57. The system of claim 13, wherein the location logic is configured to determine the location of the audience member based on: a ticket receipt/number, a venue or event code, a computing device of a venue, an IP address of a venue, a local wireless network, an image, GPS, or a QR Code.

58. The system of claim 1, wherein the audience interface logic is configured for the audience member to upvote a song request or add a tip to a song request made by another audience member.

59-60. (canceled)

61. The system of claim 1, wherein transaction logic is configured to make a payment to the DJ depending on whether a requested or sponsored song has actually been played.

62. (canceled)

63. The system of claim 1, further comprising playlist logic configured to determine a location within a playlist for a requested song based on a transition score.

64. The system of claim 1, wherein request management logic is configured to require that song requests come from audience devices disposed at one or more specific location.

65. The system of claim 1, wherein request management logic is configured to add a song from the playlist of a DJ to a request recommendation list for an event at which the playlist is played by the DJ.

66. The system of claim 1, further comprising promotion logic configured to select a song to be promoted at an event based on a playlist of the DJ for the event and add the selected song to be promoted to a request recommendation list for presentation to the audience member at the event.

67. (canceled)

68. The system of claim 1, wherein audience interface logic is configured to label sponsored content as such.
